(19) United States
(12) Patent Application Publication
(10) Pub. No.: US 2014/0074936 A1
(43) Pub. Date: Mar. 13, 2014

(54) METHOD, DEVICE, AND TERMINAL FOR SNS SYSTEM APPLICATION PROMPT

(71) Applicant: Tencent Technology (Shenzhen) Company Limited, Shenzhen (CN)

(72) Inventors: Cheng Gong NING, Shenzhen (CN); Xue Ke HUANG, Shenzhen (CN); Ming Hui WANG, Shenzhen (CN); Zhu LIANG, Shenzhen (CN); Zhi Hao ZHENG, Shenzhen (CN); Ming Zhong JI, Shenzhen (CN); Xiao Jun HUANG, Shenzhen (CN); Hua Bin XU, Shenzhen (CN); Hui Xing WANG, Shenzhen (CN); Guang Hai WEN, Shenzhen (CN); Zhi Hua WU, Shenzhen (CN)

(73) Assignee: TENCENT TECHNOLOGY (SHENZHEN) COMPANY LIMITED, Shenzhen (CN)

(21) Appl. No.: 14/077,066

(22) Filed: Nov. 11, 2013

Related U.S. Application Data
(63) Continuation of application No. PCT/CN2013/081520, filed on Aug. 15, 2013.

(30) Foreign Application Priority Data
Sep. 7, 2012 (CN) 2012103302432

(51) Int. Cl. H04L 29/08

(52) U.S. Cl. CPC H04L 67/18
USPC 709/204

(57) ABSTRACT

A method, device, and terminal for social network service (“SNS”) system application prompt are described. The method may include: obtaining location information associated with a current geographical location of a terminal; generating prompt information corresponding to the location information; and outputting the prompt information, wherein the prompt information prompts a user to start an SNS system application. The method increases SNS system applications' user loyalty and rate of utilization.

### CROSS REFERENCE TO RELATED APPLICATION

This application is a U.S. continuation application under 35 U.S.C. §111(a) claiming priority, under 35 U.S.C. §120 and 365(c), to International Application No. PCT/CN2013/081520 filed on Aug. 15, 2013, which claims the priority benefit of Chinese Patent Application No. 201210330243.2, filed Sep. 7, 2012, the contents of both the PCT application and the Chinese application are incorporated by reference herein in their entirety for all purposes.

### TECHNICAL FIELD

The present disclosure relates generally to the technological field of the Internet, particularly to the technological field of social network service (“SNS”), and more particularly, to a method, device, and terminal for SNS system application prompt.

### BACKGROUND

Location-based service (“LBS”) obtains a terminal's geographical location information via wireless communication networks such as a Global System for Mobile (“GSM”) communications network or a Code Division Multiple Access (“CDMA”) network, or via such positioning technologies as Global Positioning System (“GPS”), and provides a terminal user with services based on the geographical location information. In recent years, the LBS technology has been widely used, e.g., pushing to a terminal user based on LBS such service-for-life information about restaurants and stores around the terminal user's geographical location, etc. With the continuing development of SNS system technology, various SNS system application products emerge one after another and the competition between them are getting fiercer and fiercer. How to increase the competitiveness of applications in SNS systems based on LBS has become a technical problem to be solved by various application providers.

### SUMMARY OF THE DISCLOSURE

The present disclosure discloses a method, device, and terminal for social network service (“SNS”) system application prompt, which can increase SNS system applications' user loyalty and the rate of utilization of the SNS system applications.

A first aspect of the present disclosure discloses an SNS system application prompt method. The method can comprise:

obtaining location information associated with a current geographical location of a terminal;

generating prompt information corresponding to the location information; and

outputting the prompt information, wherein the prompt information prompts a user to start an SNS system application.

A second aspect of the present disclosure discloses an SNS system application prompt device. The device can comprise:

an obtaining module that obtains location information associated with a current geographical location of a terminal;

an information generating module that generates prompt information corresponding to the location information; and

a prompting module that outputs the prompt information, wherein the prompt information prompts a user to start an SNS system application.

A third aspect of the present disclosure discloses a terminal. The terminal can comprise the SNS system application device.

A fourth aspect of the present disclosure discloses a computer-readable memory medium storing a program which, when executed by a processor, performs some or all of the steps of the SNS system application prompt method.

The present disclosure achieves the following beneficial effects:

By obtaining location information associated with a current geographical location of a terminal, prompt information corresponding to the location information can be generated and output, wherein the prompt information prompts a user to start an SNS system application. SNS system application prompts based on LBS technology can increase the rate of utilization of SNS system applications and SNS system applications' user loyalty, thereby enhancing product competitiveness of SNS system applications.

### BRIEF DESCRIPTION OF THE DRAWINGS

FIG. 1 is a schematic diagram illustrating an example of the flow of an SNS system application prompt method according to various embodiments.

FIG. 2 is a schematic diagram illustrating an example of the flow of an SNS system application prompt method according to various embodiments.

FIG. 3 is a schematic diagram illustrating an example of the flow of an SNS system application prompt method according to various embodiments.

FIG. 4 is a schematic diagram illustrating an example of the flow of an SNS system application prompt method according to various embodiments.

FIG. 5 is a schematic diagram illustrating an example of an arrangement of an SNS system application prompt device according to various embodiments.

FIG. 6 is a schematic diagram illustrating an example of an arrangement of the information generating module illustrated in FIG. 5.

FIG. 7 is a schematic diagram illustrating an example of an arrangement of an SNS system application prompt device according to various embodiments.

FIG. 8 is a schematic diagram illustrating an example of the flow of an SNS system application prompt method according to various embodiments.

FIG. 9 is a schematic diagram illustrating an example of the flow of an SNS system application prompt method according to various embodiments.

FIG. 10 is a schematic diagram illustrating an example of an arrangement of an SNS system application prompt device according to various embodiments.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

As used herein, an SNS system refers to a platform servicing one or more Internet applications for users to build social networks. Examples of an SNS system include, but are not limited to, a platform for individual spaces and a platform for interactive websites, etc. Examples of applications that can be included in an SNS system include, but are not limited to, a weblog application, a micro-blog application, an photo album application, a comments application, a review application, a blog application, an audio and video application, and a game application. Terminals can comprise tablets, cellphones, Personal Digital Assistants (“PDAs”), electronic readers, laptops, smart TVs, on-vehicle terminals and other smart devices. A mobile terminal can be a mobile phone, a tablet PC, a media player, etc. Examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), a media player (including, but not limited to, Apple iPod and Microsoft Zoom), or an on-vehicle device running any of the above-mentioned operating systems or any other operating systems, or any other mobile Internet device (“MID”) or intelligent communication terminal, all of which are well known to those skilled in the art.

According to some embodiments, obtaining a terminal's geographical location information via LBS technology can comprise obtaining the terminal's geographical location information via a wireless communication network such as a GSM network or a CDMA network, or via positioning technology such as GPS technology. Examples of a wireless communication network include, but are not limited to, a General Packet Radio Service (“GPRS”) network, a Wideband Code Division Multiple Access (“WCDMA”) network, a Code Division Multiple Access 2000 (“CDMA2000”) network, a Time Division-Synchronous Code Division Multiple Access (“TD-SCDMA”) network, and a Time Division Long Term Evolution (“TD-LTE”) network. According to some embodiments, geographical location information can be expressed in latitude and longitude coordinates. As used herein, an administrative region refers to a region partitioned for level-to-level administration and in which relevant governmental authorities have been established. In China, an administrative region can comprise such regions as provinces, autonomous regions, municipalities directly under the Central Government, special administrative regions, districts, district-equivalents, cities, counties, and towns, etc. In countries other than China, an administrative region can comprise such regions as provinces, states, cities, and commonwealths, etc. According to the geographical coordinates system, each administrative region corresponds to a scope of latitude and longitude coordinates. Based on the latitude and longitude coordinates corresponding to the geographical location information associated with a terminal, the administrative region corresponding to the geographical location information can be ascertained. As a result, the administrative region in which the terminal is located can be determined. An administrative region can be identified by one or more of the following regional identifiers: the name of the administrative region (e.g., Beijing), an icon associated with the administrative region (e.g., an icon associated with Beijing), the name of a construction within the administrative region (e.g., Great Wall), and an icon associated with a construction within the administrative region (e.g., an icon associated with the Great Wall).

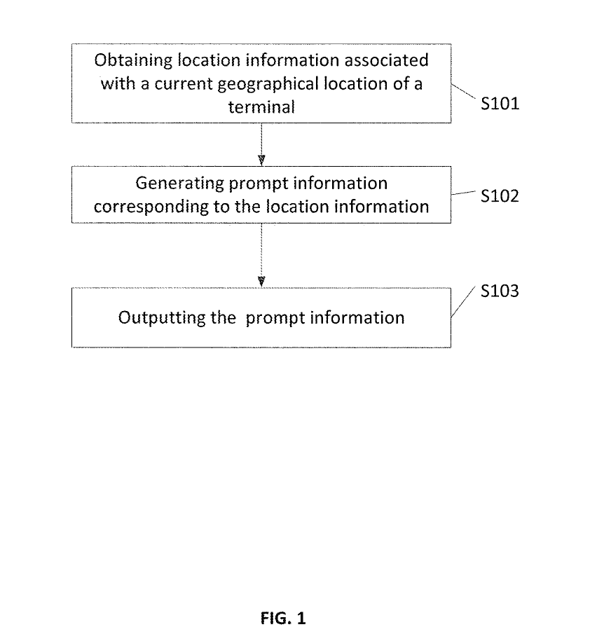

The following is a detailed description of SNS system application prompt methods according to various embodiments and as illustrated in FIGS. 1-4.

FIG. 1 is a schematic diagram illustrating an example of the flow of an SNS system application prompt method according to various embodiments. The method comprises:

Step S101: obtaining location information associated with a current geographical location of a terminal.

According to some embodiments, location information associated with a current geographical location of a terminal can be obtained based on LBS technology. By way of example only, location information associated with a current geographical location of a terminal can be obtained via a wireless communication network such as a GSM network or a CDMA network. According to some other embodiments, location information associated with a current geographical location of a terminal can be obtained via positioning technology such as GPS technology.

Step S102: generating prompt information corresponding to the location information.

According to some embodiments, the prompt information comprises SNS system application prompt information. According to some embodiments, the prompt information is SNS system application prompt information. According to some embodiments, prompts related to an SNS system application can be pre-stored on the system. By way of example only, if an SNS system comprises a photo album application, prompts such as “XX is so beautiful; take a photo of it,” or “you have arrived at XX; take photos and share them with your friends,” etc. can be pre-stored, where XX is a character position reserved for geographical location information. After obtaining location information associated with a current geographical location of a terminal, a pre-stored prompt can be extracted and combined with the location information associated with the current geographical location of the terminal, thereby generating the prompt information. By way of example only, if location information associated with a current geographical location of a terminal corresponds to the city of Beijing, then a pre-stored prompt can be extracted and “Beijing” can be inserted at a reserved character position, thereby generating such prompt information as “Beijing is so beautiful; take a photo of it” or “you have arrived at Beijing; take photos and share them with your friends,” etc.

Those skilled in the art will readily appreciate that the above-described process of generating prompt information is merely exemplary and that prompt information can be generated in other ways, e.g., prompt information can be obtained in real-time from a network or a server, etc. In addition, processes of generating prompt information for other applications in an SNS system can take reference to the process of generating application prompt information for a photo album application in an SNS system as described above and will not be described in detail again.

Step 103: outputting the prompt information.

According to some embodiments, prompt information can be used to prompt a user to start an SNS system application. According to some embodiments, outputting prompt information can comprise: sending the prompt information to a terminal for display by way of a short message. According to some other embodiments, outputting prompt information can comprise: sending the prompt information to a terminal for display by way of a notification message. Prompting a user to start an SNS system application by prompt information has the benefit of increasing the rate of utilization of SNS system applications.

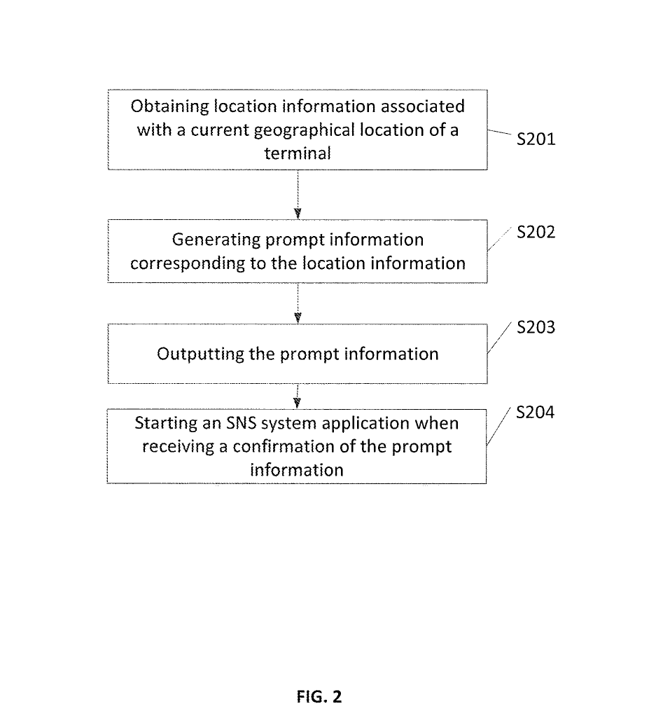

FIG. 2 is a schematic diagram illustrating an example of the flow of an SNS system application prompt method according to various embodiments. The method comprises:

Step S201: obtaining location information associated with a current geographical location of a terminal.

Step S202: generating prompt information corresponding to the location information.

Step S203: outputting the prompt information, wherein the prompt information prompts a user to start an SNS system application.

Steps S201-S203 can be carried out by taking reference to the description of Steps S101-S103 above, which will not be described in detail again.

Step S204: starting the SNS system application when receiving a confirmation of the prompt information.

According to these embodiments, the prompt information can be used to prompt a user to start an SNS system application. According to some embodiments, prompt information can comprise a link address of or entry information associated with an SNS system application. When a user performs an operation confirming certain prompt information, e.g., by clicking the prompt information, the user's confirmation of the prompt information can be received in the present step and the SNS system application can be started thereafter accordingly. By way of example only, assume that an SNS system application prompt says “you have arrived at Beijing; take photos and share them with your friends.” When a user clicks the SNS system application prompt, the user's confirmation of the SNS system application prompt information can be received in this step and a photo album application in the SNS system can be started directly thereafter.

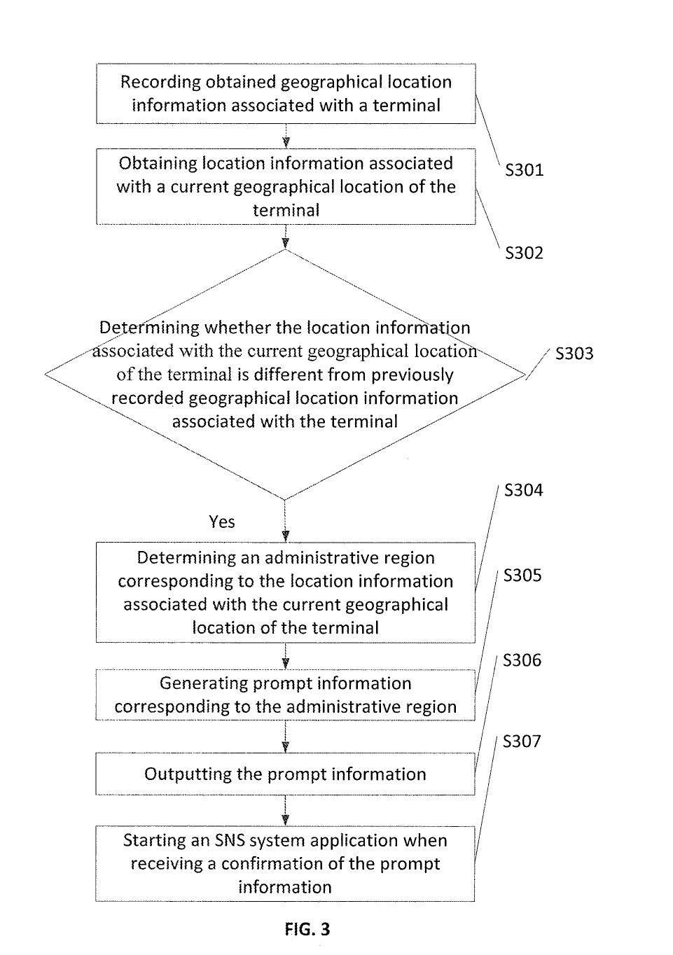

FIG. 3 is a schematic diagram illustrating an example of the flow of an SNS system application prompt method according to various embodiments. The method comprises:

Step S301: recording obtained geographical location information associated with a terminal.

According to some embodiments, geographical location information associated with a terminal can be recorded in the form of a list. According to some preferred embodiments, every time an obtained geographical location of a terminal is recorded, the time at which the geographical location information is obtained (the “obtaining time”) or a sequence number associated with the geographical location information can also be recorded at the same time. Table 1 illustrates an example of recording obtained geographical location information in the form of a list:

TABLE 1
Geographical Location Information Recording Table (1)

| Obtaining Time | Geographical Location Information |
|---|---|
| 10 Aug. 2012 | north latitude 39.9″, east longitude 116.3″ |
| 13 Aug. 2012 | east longitude 113.46″, north latitude 22.27″ |
| . . . | . . . |

Table 2 illustrates another example of recording obtained geographical information in the form of a list:

TABLE 2
Geographical Location Information Recording Table (2)

| Sequence Number | Geographical Location Information |
|---|---|
| 1 | north latitude 39.9″, east longitude 116.3″ |
| 2 | east longitude 113.46″, north latitude 22.27″ |
| . . . | . . . |

Table 1 and Table 2 are exemplary only. Recording the obtaining times or the sequence numbers can facilitate search of recorded geographical location information. Those skilled in the art can readily appreciate that the recording of obtained geographical location information can be achieved in other forms, e.g., recording by using a database, or a queue, etc. Analysis of other forms of recording can be done by taking reference to the above analysis of recording in the form of a list, which will not be described in detail again.

The frequency at which geographical location information associated with a terminal is obtained can be pre-set or user-customizable. Similarly, the frequency at which the obtained geographical location information associated with a terminal is recorded can be pre-set or user-customizable. For example, geographical location information associated with a terminal can be obtained on a daily basis, e.g., at a certain time each day, or more frequently on an hourly basis, e.g., at the top of each hour, etc. Similarly, obtained geographical location information associated with a terminal can be recorded on a daily basis, e.g., at a certain time each day, or more frequently on an hourly basis, e.g., at the top of each hour, etc. According to some embodiments, recording obtained geographical location information associated with a terminal comprises recording all obtained geographical location information associated with the terminal since the last recording. According to these embodiments, during the interval between the last recording and the current recording, the terminal may have been to multiple geographical locations, information about some or all of which may have been obtained, and all the obtained information is recorded. According to some other embodiments, recording obtained geographical location information associated with a terminal comprises recording the last obtained geographical location information associated with the terminal only. According to these embodiments, during the interval between the last recording and the current recording, the terminal may have been to multiple geographical locations, information about some or all of which may have been obtained. However, only the last obtained geographical location information is recorded and the other obtained geographical location information during the interval is all discarded. Those skilled in the art will readily appreciate that it is preferable that the frequency of recording is lower than the frequency of obtaining geographical location information associated with a terminal so that every time a recording occurs, there is at least some obtained geographical location information associated with the terminal to record.

Step S302: obtaining location information associated with a current geographical location of the terminal.

Step S303: determining whether the location information is different from previously recorded geographical location information associated with the terminal. If so, then turn to Step S304. If no, the flow ends.

According to some embodiments, the previously recorded geographical location information associated with the terminal comprises the last recorded geographical location information associated with the terminal. According to some embodiments, the previously recorded geographical location information is the last recorded geographical location information associated with the terminal. According to some embodiments, the determination can be made by searching contents recorded in Table 1 or Table 2 above. By way of example only, assume that the location information associated with a current geographical location of a terminal is: north latitude 39.9″ and east longitude 116.3″, and the obtaining time is 20 Aug. 2012. This information can be recorded in the above Table 1. In this step, by looking up the above Table 1, it can be determined whether the geographical location information obtained on 20 Aug. 2012 is different from the geographical location information obtained on 13 Aug. 2012. If so, then turn to Step S304. Another example: assume that the location information associated with a current geographical location of a terminal is: north latitude 39.9″ and east longitude 116.3″, and the sequence number of the recording is 3. This information can be recorded in the above Table 2. By looking up the above Table 2, it can be determined whether the geographical location information corresponding to sequence number 3 is different from the geographical location information corresponding to sequence number 2. If so, then turn to Step S304.

Whether one piece of geographical location information is different from another piece of geographical location information is related to how precisely geographical location information is obtained and the cut off of the latitude and longitude coordinates. By way of example only, if the cut off is two digits after the decimal point, then east longitude 113.46″, north latitude 22.27″ would be considered a different geographical location from east longitude 113.47″, north latitude 22.27″, and east longitude 113.46″, north latitude 22.28″ would be considered yet a different geographical location. As a result, geographical location information representing the three longitude/latitude coordinate pairs would all be different from each other. In contrast, if the cut off is only one digit after the decimal points, then these three pairs of longitude/latitude coordinates may be considered to correspond to a same geographical location and they may have the same geographical location information. How precisely geographical location information can be obtained, e.g., in terms of the preciseness of the latitude/longitude coordinate pairs, can be either pre-set or user-customizable. Similarly, the cut off of the latitude and longitude coordinates for the purpose of determining whether one piece of geographical location information is different from another piece of geographical location information can also be pre-set or user-customizable.

Step S304: determining an administrative region corresponding to the location information.

According to the geographical coordinates system, each administrative region corresponds to a scope of latitude and longitude coordinates. Based on the latitude and longitude coordinates corresponding to the geographical location information associated with a terminal, the administrative region corresponding to the geographical location information can be ascertained. For example, according to the geographical coordinate system, the longitude-latitude coordinates scope corresponding to Shenzhen is: east longitude 113.52″˜114.21″ and north latitude 22.27″˜22.39″. Based on this, it can be determined that in the above Table 1, the administrative region corresponding to the geographical location information obtained on 13 Aug. 2012 is Shenzhen. Similarly, based on this, it can be determined that in the above Table 2, the administrative region corresponding to the geographical location information corresponding to sequence number 2 is Shenzhen.

Step S305: generating prompt information corresponding to the administrative region.

According to some embodiments, prompts related to an SNS system application can be pre-stored on the system. By way of example only, if an SNS system comprises a photo album application, prompts such as “XX is so beautiful; take a photo of it,” or “you have arrived at XX; take photos and share them with your friends,” etc. can be pre-stored, where XX is a character position reserved for geographical location information. After determining an administrative region, a pre-stored prompt can be extracted and combined with a regional identifier associated with the administrative region, thereby generating prompt information. By way of example only, if the administrative region is Shenzhen, and a regional identifier associated with the administrative region is its name “Shenzhen,” then a pre-stored prompt can be extracted and the name “Shenzhen” can be inserted at a reserved character position, thereby generating such prompt information as “Shenzhen is so beautiful; take a photo of it” or “you have arrived at Shenzhen; take photos and share them with your friends,” etc.

In the embodiments illustrated in FIG. 3, Steps S304 and S305 can be considered detailed processes for carrying out Step S102 illustrated in FIG. 1 or Step S202 illustrated in FIG. 2.

According to some embodiments, different pieces of geographical location information can correspond to different administrative regions. According to these embodiments, prompt information can be generated when a terminal enters a different administrative region. According to some embodiments, different pieces of geographical location information can correspond to a same administrative region. According to these embodiments, same prompt information can be generated more than once when the terminal remains in a same administrative region but is considered to have entered into different geographical locations. Alternatively, it can be either pre-set or user-customizable that the same prompt information is generated only once or up to a certain number of times when the terminal is within an administrative region, regardless of how many times different geographical location information has been obtained.

Step S306: outputting the prompt information, wherein the prompt information prompts a user to start an SNS system application.

According to some embodiments, the prompt information comprises SNS system application prompt information. According to some embodiments, the prompt information is SNS system application prompt information. According to some embodiments, different pieces of geographical location information can correspond to different administrative regions. According to these embodiments, prompt information can be generated and output when a terminal enters a different administrative region. According to some embodiments, different pieces of geographical location information can correspond to a same administrative region. According to these embodiments, same prompt information can be generated and output more than once when the terminal remains in a same administrative region but is considered to have entered into different geographical locations. Alternatively, it can be either pre-set or user-customizable that the same prompt information is output only once or up to a certain number of times when the terminal is within an administrative region, regardless of how many times different geographical location information has been obtained and how many times the same prompt information is generated.

Step S307: starting the SNS system application when receiving a confirmation of the prompt information.

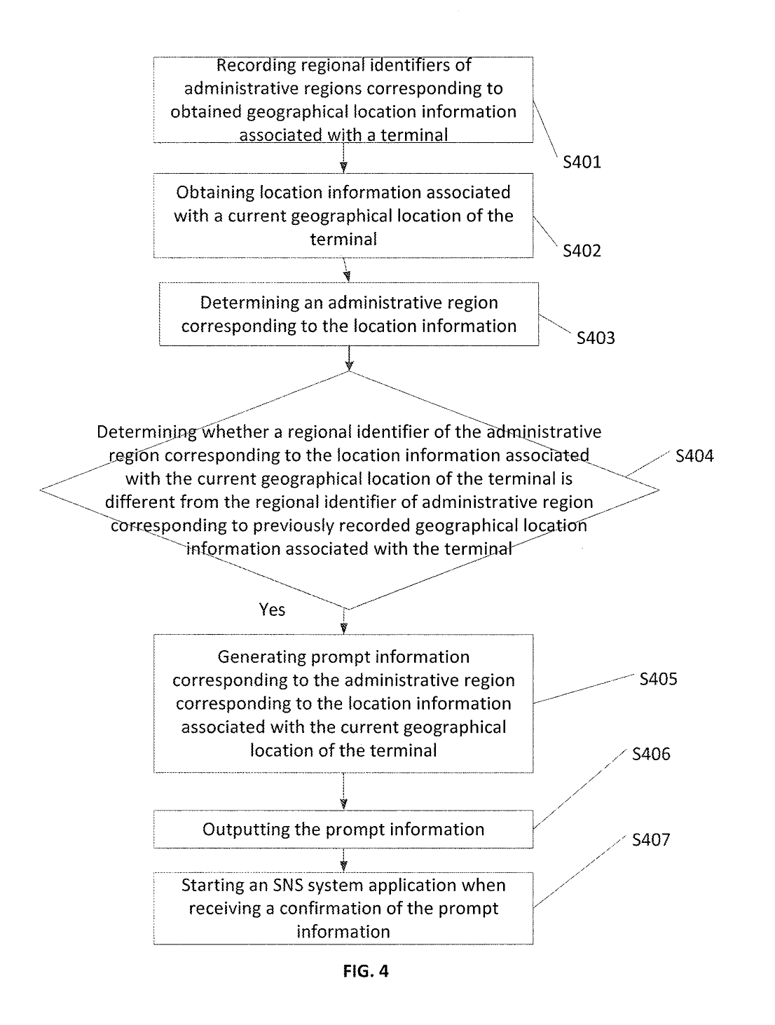

FIG. 4 is a schematic diagram illustrating an example of the flow of an SNS system application prompt method according to various embodiments.

Step S401: recording regional identifiers of administrative regions corresponding to obtained geographical location information associated with a terminal.

According to some embodiments, regional identifiers of administrative regions corresponding to obtained geographical location information associated with a terminal can be recorded in the form of a list. According to some preferred embodiments, every time a regional identifier of an administrative region corresponding to an obtained geographical location of a terminal is recorded, the obtaining time or a sequence number associated with the administrative region can also be recorded at the same time.

Table 3 illustrates an example of recording regional identifiers of administrative regions corresponding to obtained geographical location information in the form of a list:

TABLE 3
Geographical Location Information Recording Table (3)

| Obtaining Time | Regional Identifier of Administrative Region |
|---|---|
| 10 Aug. 2012 | “Beijing” |
| 13 Aug. 2012 | “Shenzhen” |
| . . . | . . . |

Table 4 illustrates another example of recording regional identifiers of administrative regions corresponding to obtained geographical information in the form of a list:

TABLE 4
Geographical Location Information Recording Table (4)

| Sequence Number | Regional Identifier of Administrative Region |
|---|---|
| 1 | “Beijing” |
| 2 | “Shenzhen” |
| . . . | . . . |

Table 3 and Table 4 are exemplary only. Recording the obtaining times or the sequence numbers can facilitate search of recorded administrative regions. Those skilled in the art can readily appreciate that the recording of administrative regions corresponding to obtained geographical location information can be achieved in other forms, e.g., recording by using a database, or a queue, etc. Analysis of other forms of recording can be done by taking reference to the above analysis of recording in the form of a list, which will not be described in detail again.

The frequency at which geographical location information associated with a terminal is obtained can be pre-set or user-customizable. Similarly, the frequency at which regional identifiers of administrative regions corresponding to obtained geographical location information associated with a terminal are recorded can be pre-set or user-customizable. For example, geographical location information associated with a terminal can be obtained on a daily basis, e.g., at a certain time each day, or more frequently on an hourly basis, e.g., at the top of each hour, etc. Similarly, regional identifiers of administrative regions corresponding to obtained geographical location information associated with a terminal can be recorded on a daily basis, e.g., at a certain time each day, or more frequently on an hourly basis, e.g., at the top of each hour, etc. According to some embodiments, recording regional identifiers of administrative regions corresponding to obtained geographical location information associated with a terminal comprises recording regional identifiers of administrative regions corresponding to all obtained geographical location information associated with a terminal since the last recording. According to these embodiments, during the interval between the last recording and the current recording, the terminal may have been to multiple geographical locations, information about some or all of which may have been obtained, and regional identifiers of administrative regions corresponding to all the obtained geographical location information associated with a terminal are recorded. According to some other embodiments, recording regional identifiers of administrative regions corresponding to obtained geographical location information associated with a terminal comprises recording a regional identifier of an administrative region corresponding to the last obtained geographical location information associated with a terminal only. According to these embodiments, during the interval between the last recording and the current recording, the terminal may have been to multiple geographical locations, information about some or all of which may have been obtained. However, only a regional identifier of an administrative region corresponding to the last obtained geographical location information associated with a terminal is recorded and the regional identifiers of administrative regions corresponding to other geographical location information associated with the terminal obtained during the interval is all discarded. Those skilled in the art will readily appreciate that it is preferable that the frequency of recording is lower than the frequency of obtaining geographical location information associated with a terminal so that every time a recording occurs, there is at least some obtained geographical location information associated with the terminal so that regional identifier(s) of one or more administrative regions corresponding to some obtained geographical location information can be recorded.

Step S402: obtaining location information associated with a current geographical location of the terminal.

Step S403: determining an administrative region corresponding to the location information associated with the current geographical location of the terminal.

Step S404: determining whether a regional identifier of the administrative region corresponding to the location information associated with the current geographical location of the terminal is different from the regional identifier of administrative region corresponding to previously obtained geographical location information associated with the terminal. If so, then turn to Step S405. If no, the flow ends.

According to some embodiments, the previously obtained geographical location information associated with the terminal comprises the last obtained geographical location information associated with the terminal. According to some embodiments, the previously obtained geographical location information associated with the terminal is the last obtained geographical location information associated with the terminal. According to some embodiments, the determination can be made by searching contents recorded in Table 3 or Table 4 above. By way of example only, assume that the administrative region corresponding to location information associated with a current geographical location of a terminal is Beijing, and the obtaining time is 20 Aug. 2012. This information can be recorded in the above Table 3. In this step, by looking up the above Table 3, it can be determined whether the regional identifier of the administrative region obtained on 20 Aug. 2012 is different from the regional identifier of the administrative region obtained on 13 Aug. 2012. If so, then turn to Step S404. Another example: assume that the administrative region corresponding to location information associated with a current geographical location of a terminal is Beijing, and the sequence number of the recording is 3. This information can be recorded in the above Table 4. By looking up the above Table 4, it can be determined whether the regional identifier of administrative region corresponding to sequence number 3 is different from the regional identifier of administrative region corresponding to sequence number 2. If so, then turn to Step S405.

Step S405: generating prompt information corresponding to the administrative region corresponding to the location information associated with the current geographical location of the terminal.

Step S406: outputting the prompt information, wherein the prompt information prompts a user to start an SNS system application.

Step S407: starting the SNS system application when receiving a confirmation of the prompt information.

As described above, by obtaining location information associated with a current geographical location of a terminal, prompt information based on the location information associated with the current geographical location of the terminal can be generated and output, wherein the prompt information prompts a user to start an SNS system application. SNS system application prompts based on LBS technology can increase the rate of utilization of SNS system applications and SNS system applications' user loyalty, thereby enhancing product competitiveness of SNS system applications.

Persons of ordinary skill in the art can readily appreciate that all or part of the steps of the SNS system application prompt methods described in the embodiments illustrated in FIGS. 1-4 above can be executed by relevant hardware instructed by a program that may be stored in a non-transitory computer-readable memory medium. The present disclosure discloses such non-transitory computer-readable memory medium.

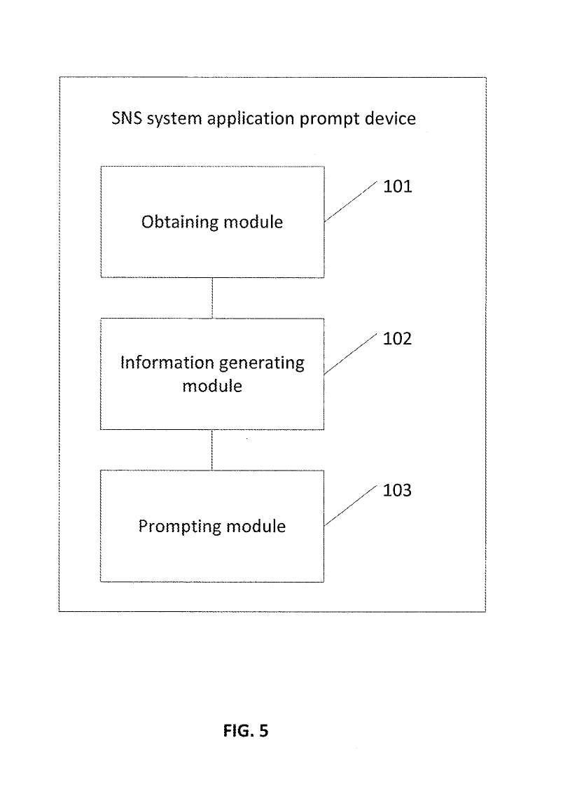

The following is a detailed description of SNS system application prompt devices according to various embodiments and as illustrated in FIGS. 5-7. The devices can be used to carry out any of the methods illustrated in FIGS. 1-4.

FIG. 5 is a schematic diagram illustrating an example of an arrangement of an SNS system application prompt device according to various embodiments. The device comprises: an obtaining module 101, an information generating module 102, and a prompting module 103.

The obtaining module 101 obtains location information associated with a current geographical location of a terminal.

According to some embodiments, the obtaining module 101 can obtain location information associated with a current geographical location of a terminal based on LBS technology. According to some embodiments, the obtaining module 101 can obtain location information associated with a current geographical location of a terminal via a wireless network such as a GSM network or a CDMA network. According to some other embodiments, the obtaining module 101 can obtain location information associated with a current geographical location of a terminal via positioning technology such as GPS technology.

The information generating module 102 generates prompt information corresponding to the location information.

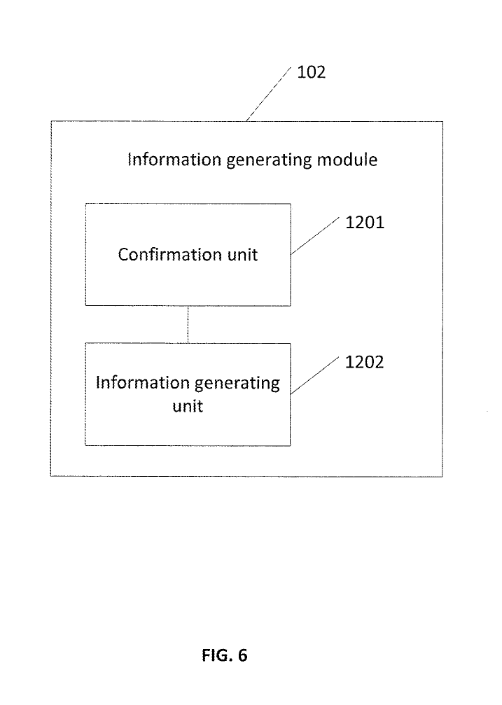

FIG. 6 is a schematic diagram illustrating an example of an arrangement of the information generating module illustrated in FIG. 5. The information generating module 102 comprises: a confirmation unit 1201 and an information generating unit 1202.

The confirmation unit 1201 determines an administrative region corresponding to the location information associated with the current geographical location of the terminal.

According to the geographical coordinates system, each administrative region corresponds to a scope of latitude and longitude coordinates. Based on the latitude and longitude coordinates corresponding to the geographical location information associated with a terminal, the confirmation unit 1201 can determine the administrative region corresponding to the geographical location information.

The information generating unit 1202 generates prompt information corresponding to the administrative region.

According to some embodiments, prompts related to an SNS system application can be pre-stored on the system. After an administrative region is determined, the information generating unit 1202 can extract a pre-stored prompt and combine it with a regional identifier of the administrative region, thereby generating prompt information.

The prompting module 103 outputs the prompt information, wherein the prompt information prompts a user to start an SNS system application.

According to some embodiments, the prompting module 103 outputs prompt information by sending the prompt information to a terminal for display by way of a short message. According to some other embodiments, the prompting module 103 outputs prompt information by sending the prompt information to a terminal for display by way of a notification message. Prompting a user to start an SNS system application by prompt information has the benefit of increasing the rate of utilization of SNS system applications.

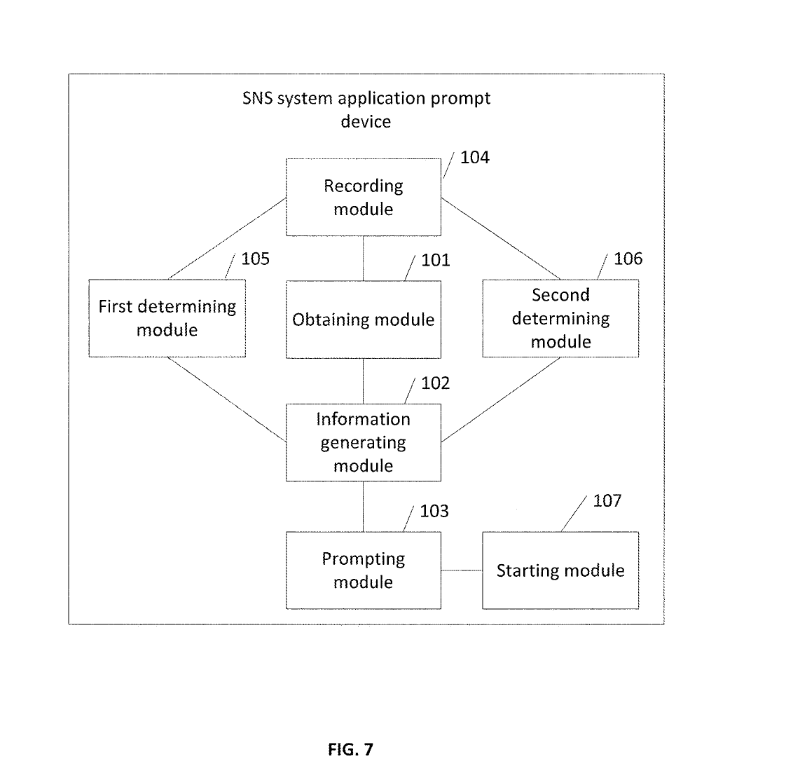

FIG. 7 is a schematic diagram illustrating an example of an arrangement of an SNS system application prompt device according to various embodiments. The device comprises: an obtaining module 101, information generating module 102, a prompting module 103, a recording module 104, a first determining module 105, a second determining module 106, and a starting module 107. Structures and functions of obtaining module 101, information generating module 102, and prompting module 103 have been described hereinabove taking reference to FIG. 5, and will not be described in detail again.

The recording module 104 records obtained geographical location information associated with a terminal or regional identifiers of administrative regions corresponding to the obtained geographical location information associated with the terminal.

According to some embodiments, the recording module 104 can record in the form of a list, which records obtained geographical location information associated with a terminal, such as the above Table 1 or Table 2. According to some embodiments, the recording module 104 can record in the form of a list, which records regional identifiers of administrative regions corresponding to obtained geographical location information associated with a terminal, such as the above Table 3 or Table 4.

The first determining module 105 determines whether the location information associated with the current geographical location of the terminal is different from previously recorded geographical location information. If so, then it notifies the information generating module to generate prompt information corresponding to the location information associated with the current geographical location of the terminal. According to some embodiments, the previously recorded geographical location information comprises the last recorded geographical location information. According to some embodiments, the previously recorded geographical location information is the last recorded geographical location information.

The second determining module 106 determines whether a regional identifier of an administrative region corresponding to the location information associated with the current geographical location of the terminal is different from a regional identifier of an administrative region corresponding to previously recorded geographical location information. If so, then it notifies the information generating module to generate prompt information corresponding to the location information associated with the current geographical location of the terminal. According to some embodiments, the previously recorded geographical location information comprises the last recorded geographical location information. According to some embodiments, the previously recorded geographical location information is the last recorded geographical location information.

The starting module 107 receives a confirmation of the prompt information and starts an SNS system application.

According to these embodiments, prompt information can be used to prompt a user to start an SNS system application. According to some embodiments, prompt information can comprise a link address of or entry information associated with an SNS system application. When a user performs an operation confirming certain prompt information, e.g., by clicking the prompt information, the starting module 107 can receive the user's confirmation of the prompt information and the SNS system application can be started thereafter accordingly. By way of example only, assume that an SNS system application prompt says “you have arrived at Beijing; take photos and share them with your friends.” When a user clicks the SNS system application prompt, the starting module 107 receives the user's confirmation of the SNS system application prompt information and starts a photo album application in the SNS system.

Functions of the various modules in the SNS system application prompt devices described above can be achieved by the methods described in detail further above, which will not be described in detail again.

Using the devices described above, by obtaining location information associated with a current geographical location of a terminal, prompt information based on the location information can be generated and output, wherein the prompt information prompts a user to start an SNS system application. SNS system application prompts based on LBS technology can increase the rate of utilization of SNS system applications and SNS system applications' user loyalty, thereby enhancing product competitiveness of SNS system applications.

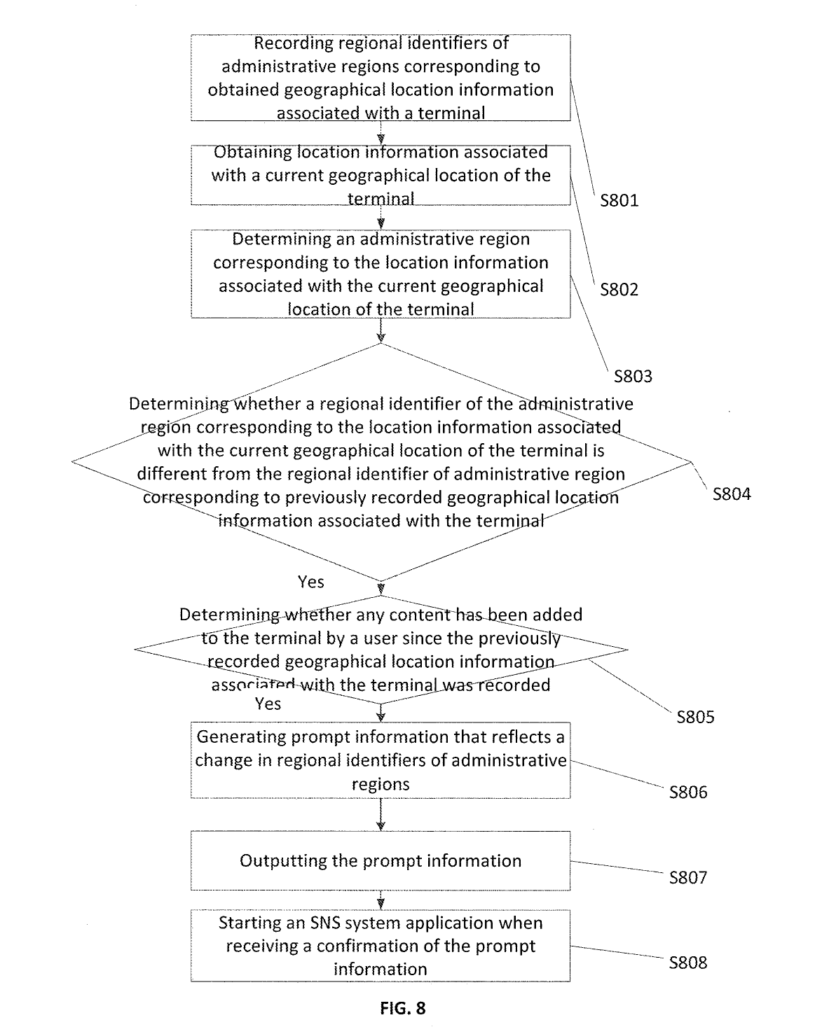

FIG. 8 is a schematic diagram illustrating an example of the flow of an SNS system application prompt method according to various embodiments.

Step S801: recording regional identifiers of administrative regions corresponding to obtained geographical location information associated with a terminal. Methods of recording regional identifiers of administrative regions corresponding to obtained geographical location information associated with a terminal have been described in detail hereinabove.

Step S802: obtaining location information associated with a current geographical location of the terminal.

Step S803: determining an administrative region corresponding to the location information associated with the current geographical location of the terminal.

Step S804: determining whether a regional identifier of the administrative region corresponding to the location information associated with the current geographical location of the terminal is different from a regional identifier of an administrative region corresponding to previously obtained geographical location information associated with the terminal. If so, then turn to Step S805. Methods of determining whether a regional identifier of an administrative region corresponding to the location information associated with the current geographical location of the terminal is different from the regional identifier of administrative region corresponding to previously recorded geographical location information associated with the terminal have been described in detail hereinabove. According to some embodiments, the previously obtained geographical location information comprises the last obtained geographical location information. According to some embodiments, the previously obtained geographical location information is the last obtained geographical location information.

Step S805: determining whether any content has been added to the terminal by a user since the previously recorded geographical location information associated with the terminal was recorded. If so, then turn to Step 806. As used herein, content refers to electronic content such as one or more electronic documents generated by a user. By way of example only, a user may have taken a number of pictures using a terminal, which was in one administrative region before but is now in another administrative region.

Step S806: generating prompt information that reflects a change in regional identifiers of administrative regions based on the regional identifier of the administrative region corresponding to the location information associated with the current geographical location of the terminal or the regional identifier of administrative region corresponding to the previously recorded geographical location information associated with the terminal, or both.

According to some embodiments, prompts related to an SNS system application can be pre-stored on the system. By way of an example only, if an SNS system comprises a photo album application, prompts such as “you have left XX; upload pictures taken after you left XX,” or “you have arrived at YY; upload pictures you have taken before you arrived at YY,” etc. can be pre-stored, where XX and YY are character positions reserved for administrative regions. After determining in Step S805 that one or more pictures have been taken and stored in the terminal by a user since the previously recorded geographical location information associated with the terminal was recorded, a pre-stored prompt can be extracted and combined with a regional identifier of either the administrative region corresponding to the location information associated with the current geographical location of the terminal or the administrative region corresponding to the previously recorded geographical location information associated with the terminal, or both. By way of example only, if the administrative region corresponding to the location information associated with the current geographical location of the terminal is Shenzhen, and the administrative region corresponding to the previously recorded geographical location information associated with the terminal is Beijing, then a pre-stored prompt can be extracted and the name “Shenzhen” or “Beijing” or both names can be inserted at a reserved character position, thereby generating such prompt information as “you have left Beijing; upload pictures taken after you left Beijing,” or “you have arrived at Shenzhen; upload pictures you have taken before you arrived at Shenzhen,” etc.

Step S807: outputting the prompt information, wherein the prompt information prompts a user to start an SNS system application.

Step S808: starting the SNS system application when receiving a confirmation of the prompt information.

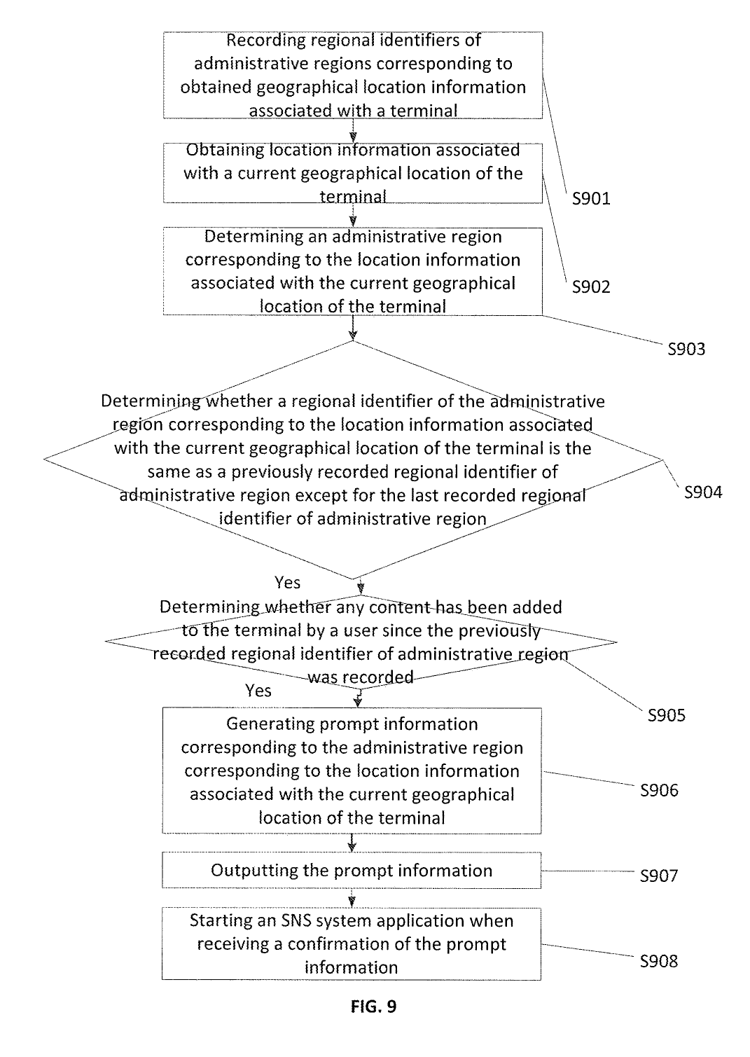

FIG. 9 is a schematic diagram illustrating an example of the flow of an SNS system application prompt method according to various embodiments.

Step S901: recording regional identifiers of administrative regions corresponding to obtained geographical location information associated with a terminal. Methods of recording regional identifiers of administrative regions corresponding to obtained geographical location information associated with a terminal have been described in detail hereinabove.

Step S902: obtaining location information associated with a current geographical location of the terminal.

Step S903: determining an administrative region corresponding to the location information associated with the current geographical location of the terminal.

Step S904: determining whether a regional identifier of the administrative region corresponding to the location information associated with the current geographical location of the terminal is the same as a previously recorded regional identifier of administrative region corresponding to obtained geographical location information associated with the terminal except for the last recorded regional identifier of administrative region. If so, then turn to Step S905. Methods of determining whether a regional identifier of the administrative region corresponding to the location information associated with the current geographical location of the terminal is the same as a previously recorded regional identifier of administrative region corresponding to obtained geographical location information associated with the terminal except for the last recorded regional identifier of administrative region can take reference to methods of determining whether a regional identifier of the administrative region corresponding to the location information associated with the current geographical location of the terminal is different from the regional identifier of administrative region corresponding to the last recorded geographical location information associated with the terminal, which have been described in detail hereinabove.

Step S905: determining whether any content has been added to the terminal by a user since the previously recorded regional identifier of administrative region was recorded. If so, then turn to Step 906.

Step S906: generating prompt information corresponding to the administrative region corresponding to the location information associated with the current geographical location of the terminal.

According to some embodiments, prompts related to an SNS system application can be pre-stored on the system. By way of an example only, if an SNS system comprises a photo album application, prompts such as “you have returned to XX; upload pictures taken while you were away” etc. can be pre-stored, where XX is character positions reserved for an administrative region. After determining in Step S905 that one or more pictures have been taken and stored in the terminal by a user since the previously recorded regional identifier of administrative region was recorded, a pre-stored prompt can be extracted and combined with a regional identifier of the administrative region corresponding to the location information associated with the current geographical location of the terminal, which is also the previously recorded regional identifier of administrative region. By way of example only, if the administrative region corresponding to the location information associated with the current geographical location of the terminal is Shenzhen, then a pre-stored prompt can be extracted and the name “Shenzhen” can be inserted at a reserved character position, thereby generating such prompt information as “you have returned to Shenzhen; upload pictures taken while you were away” etc.

Step S907: outputting the prompt information, wherein the prompt information prompts a user to start an SNS system application.

Step S908: starting the SNS system application when receiving a confirmation of the prompt information.

As described above, by obtaining geographical location information associated with a terminal, prompt information based on the geographical location information associated with the terminal can be generated and output, wherein the prompt information prompts a user to start an SNS system application. SNS system application prompts based on LBS technology can increase the rate of utilization of SNS system applications and SNS system applications' user loyalty, thereby enhancing product competitiveness of SNS system applications.

According to some embodiments, the methods illustrated in FIGS. 8-9 can comprise a step of organizing and displaying the content which has been determined to have been added by the user to the user for the user's processing. According to some preferred embodiments, the organized and displayed content can be processed by the user using the SNS system application started in Steps S808 or S908.

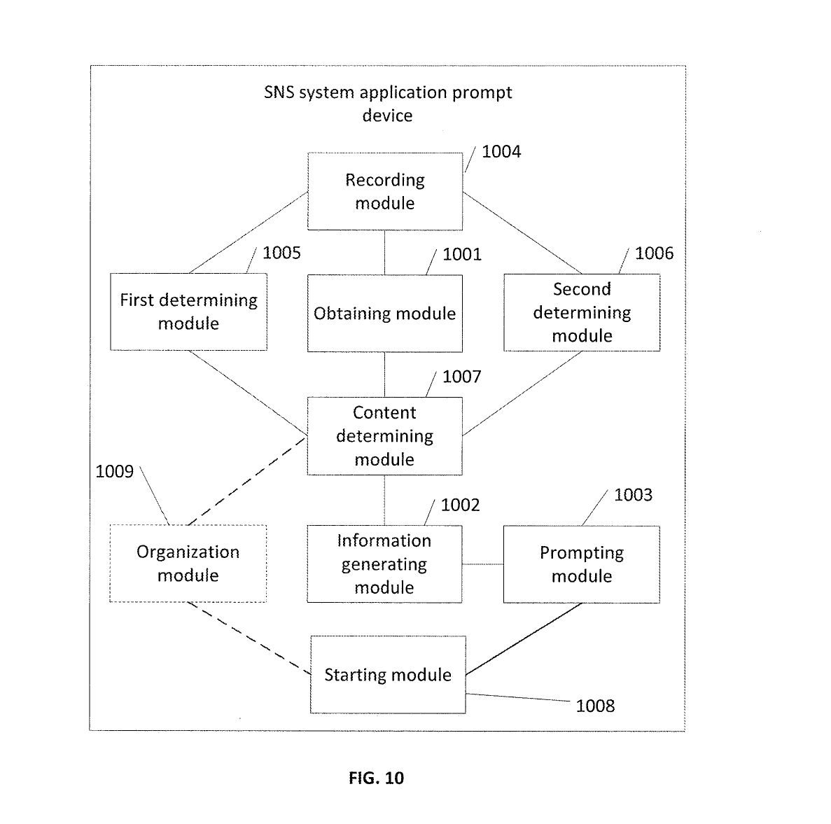

The following is a detailed description of SNS system application prompt devices according to various embodiments and as illustrated in FIG. 10. The devices can be used to carry out any of the methods illustrated in FIGS. 8-9.

FIG. 10 is a schematic diagram illustrating an example of an arrangement of an SNS system application prompt device according to various embodiments. The device comprises: an obtaining module 1001, information generating module 1002, a prompting module 1003, a recording module 1004, a first determining module 1005, a second determining module 1006, a content determining module 1007, and a starting module 1008. Structures and functions of obtaining module 1001 and prompting module 1003 have been described hereinabove taking reference to FIG. 5 (wherein the two modules are labeled 101 and 103, respectively) and will not be described in detail again.

The information generating module 1002 generates prompt information that reflects a change in regional identifiers of administrative regions based on a regional identifier of an administrative region corresponding to location information associated with a current geographical location of the terminal or a regional identifier of administrative region corresponding to the last recorded geographical location information associated with the terminal, or both, or generates SNS system application prompt information corresponding to the administrative region corresponding to the location information associated with the current geographical location of the terminal.

The recording module 1004 records regional identifiers of administrative regions corresponding to the obtained geographical location information associated with the terminal.

The first determining module 1005 determines whether a regional identifier of an administrative region corresponding to location information associated with a current geographical location of the terminal is different from a regional identifier of an administrative region corresponding to the last recorded geographical location information associated with the terminal. If so, then it notifies the content determining module 1007 to determine whether any content has been added to the terminal by a user since the last geographical location information associated with the terminal was recorded.

The second determining module 1006 determines whether a regional identifier of the administrative region corresponding to the location information associated with the current geographical location of the terminal is the same as a previously recorded regional identifier of administrative region corresponding to obtained geographical location information associated with the terminal except for the last recorded regional identifier of administrative region. If so, then it notifies the content determining module 1007 to determine whether any content has been added to the terminal by a user since the previously recorded regional identifier of administrative region was recorded.

The content determining module 1007 determines whether any content has been added to the terminal by a user since the last geographical location information associated with the terminal was recorded, or whether any content has been added to the terminal by a user since the previously recorded regional identifier of administrative region was recorded. If so, it notifies the information generating module 1002 to generate prompt information that reflects a change in regional identifiers of administrative regions based on a regional identifier of an administrative region corresponding to the location information associated with the current geographical location of the terminal or a regional identifier of administrative region corresponding to the last recorded geographical location information associated with the terminal, or both, or generate SNS system application prompt information corresponding to the administrative region corresponding to the location information associated with the current geographical location of the terminal.

The starting module 1008 receives a confirmation of the prompt information and starts an SNS system application.

According to some embodiments, the prompt information comprises SNS system application prompt information. According to some embodiments, the prompt information is SNS system application prompt information. According to these embodiments, prompt information can be used to prompt a user to start an SNS system application. According to some embodiments, prompt information can comprise a link address of or entry information associated with an SNS system application. When a user performs an operation confirming certain prompt information, e.g., by clicking the prompt information, the starting module 1008 can receive the user's confirmation of the prompt information and the SNS system application can be started thereafter accordingly. By way of example only, assume that an SNS system application prompt says “you have returned to Shenzhen; upload pictures taken while you were away.” When a user clicks the SNS system application prompt, the starting module 1008 receives the user's confirmation of the SNS system application prompt information and starts a photo album application in the SNS system or another SNS system application that can upload pictures.

According to some embodiments, the device illustrated in FIG. 10 can comprise an organization module 1009 that organizes and displays the content which has been determined to have been added by a user to the user for the user's processing. According to some preferred embodiments, the organized and displayed content can be processed by the user using the SNS system application started by the starting module 1008.

Functions of the various modules in the SNS system application prompt devices described above can be achieved by the methods described in detail further above, which will not be described in detail again.

Using the devices described above, by obtaining geographical location information associated with a terminal, prompt information based on the geographical location information associated with the terminal can be generated and output, wherein the prompt information prompts a user to start an SNS system application. SNS system application prompts based on LBS technology can increase the rate of utilization of SNS system applications and SNS system applications' user loyalty, thereby enhancing product competitiveness of SNS system applications.

The present disclosure also discloses a terminal, which can comprise any one of the SNS system application prompt devices illustrated in FIGS. 5-7 and 10. The terminal of the present disclosure can be used in any one of the methods illustrated in FIGS. 1-4 and 8-9. Structures and functions of SNS system application prompt devices in the terminal of the present disclosure have been described in various embodiments hereinabove, and will not be described in detail again.

Using the terminal described above, by obtaining current geographical location information associated with a terminal, prompt information based on the location information associated with a current geographical location of a terminal can be generated and output, wherein the prompt information prompts a user to start an SNS system application. SNS system application prompts based on LBS technology can increase the rate of utilization of SNS system applications and SNS system applications' user loyalty, thereby enhancing product competitiveness of SNS system applications.

Persons of ordinary skill in the art can readily appreciate that all or part of the steps of the SNS system application prompt methods described in the embodiments illustrated in FIGS. 1-4 and 8-9 above can be executed by relevant hardware instructed by a program that may be stored in a non-transitory computer-readable memory medium. The present disclosure discloses such non-transitory computer-readable memory medium.

Persons of ordinary skill in the art can readily appreciate that all or part of the steps of the methods described in the embodiments above can be executed by relevant hardware instructed by a program that may be stored in a non-transitory computer-readable memory medium. The readable memory medium may be, for example, a read-only memory (“ROM”), a random access memory (“RAM”), a magnetic disk or a compact disc.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. A social network service (SNS) system application prompt method comprising:
obtaining location information associated with a current geographical location of a terminal,
generating prompt information corresponding to the location information, and
outputting the prompt information, wherein the prompt information prompts a user to start an SNS system application.

2. The method of claim 1, wherein generating prompt information corresponding to the location information comprises:
determining an administrative region corresponding to the location information, and
generating prompt information corresponding to the administrative region, wherein
the prompt information comprises a regional identifier of the administrative region comprising at least one of: a name associated with the administrative region, an icon associated with the administrative region, a name of a construction within the administrative region, and an icon associated with a construction within the administrative region.

3. The method of claim 1, comprising:
recording obtained geographical location information associated with the terminal.

4. The method of claim 3, comprising:
determining whether the location information associated with the current geographical location of the terminal is different from previously recorded geographical location information associated with the terminal, wherein
generating prompt information corresponding to the location information comprises
generating the prompt information upon the condition that the location information associated with the current geographical location of the terminal is different from the previously recorded geographical location information associated with the terminal.

5. The method of claim 1, comprising:
recording regional identifiers of administrative regions corresponding to obtained geographical location information associated with the terminal.

6. The method of claim 5, comprising
determining whether a regional identifier of an administrative region corresponding to the location information associated with the current geographical location of the terminal is different from a previously recorded regional identifier of an administrative region corresponding to previously obtained geographical location information associated with the terminal, wherein
generating prompt information corresponding to the location information comprises
generating the prompt information upon the condition that the regional identifier of the administrative region corresponding to the location information associated with the current geographical location of the terminal is different from the previously recorded regional identifier of the administrative region corresponding to the previously obtained geographical location information associated with the terminal.

7. The method of claim 1, comprising:
starting the SNS system application upon the condition that receiving a confirmation of the prompt information, wherein the SNS system application comprises at least one of:
a weblog application, a micro-blog application, a photo album application, a comments application, a review application, a blog application, an audio and video application, and a game application.

8. The method of claim 1, wherein obtaining location information associated with a current geographical location of a terminal comprises obtaining the location information via a wireless communication network.

9. The method of claim 1, wherein obtaining location information associated with a current geographical location of a terminal comprises obtaining the location information via positioning technology.

10. A social network service (SNS) system application prompt device comprising:
an obtaining module that obtains location information associated with a current geographical location of a terminal,
an information generating module that generates prompt information corresponding to the location information, and
a prompting module that outputs the prompt information, wherein the prompt information prompts a user to start an SNS system application.

11. The device of claim 10, wherein the information generating module comprises:
a confirmation unit that determines an administrative region corresponding to the location information, and
an information generating unit that generates prompt information corresponding to the administrative region, wherein
the prompt information comprises a regional identifier of the administrative region comprising at least one of: a name of the administrative region, an icon associated with the administrative region, a name of a construction within the administrative region, and an icon associated with a construction within the administrative region.

12. The device of claim 10, comprising:
a recording module that records obtained geographical location information associated with the terminal.

13. The device of claim 12, comprising:
a determining module that determines whether the location information associated with the current geographical location of the terminal is different from previously recorded geographical location information associated with the terminal, and notifies the information generating module to generate prompt information corresponding to the location information associated with the current geographical location of the terminal only when the location information associated with the current geographical location of the terminal is different from the previously recorded geographical location information associated with the terminal.

14. The device of claim 10, comprising:
a recording module that records regional identifiers of administrative regions corresponding to obtained geographical location information associated with the terminal.

15. The device of claim 14, comprising:
a determining module that determines whether a regional identifier of an administrative region corresponding to the location information associated with the current geographical location of the terminal is different from a previously recorded regional identifier of an administrative region corresponding to previously obtained geographical location information associated with the terminal, and notifies the information generating module to generate prompt information corresponding to the location information associated with the current geographical location of the terminal upon the condition that the regional identifier of the administrative region corresponding to the location information associated with the current geographical location of the terminal is different from the previously recorded regional identifier of the administrative region corresponding to the previously obtained geographical location information associated with the terminal.

16. The device of claim 10, comprising:
a starting module that receives a confirmation of the prompt information and starts an SNS system application, wherein the SNS system application comprises at least one of: a weblog application, a micro-blog application, an photo album application, a comments application, a review application, a blog application, an audio and video application, and a game application.

17. The device of claim 10, wherein the obtaining module obtains the location information via a wireless communication network.

18. The device of claim 10, wherein the obtaining module obtains the location information via positioning technology.

19. A non-transitory computer readable medium used in conjunction with a social network service (SNS) system, the computer readable medium comprising instructions for:
obtaining location information associated with a current geographical location of a terminal,
generating prompt information corresponding to the location information, and
outputting the prompt information, wherein the prompt information prompts a user to start an SNS system application.
